(19) United States
(12) Patent Application Publication
(10) Pub. No.: US 2005/0249845 A1
(43) Pub. Date: Nov. 10, 2005

(54) Process for preparing filled cracker products

(76) Inventors: Mihaelos N. Mihalos, Palisades Park, NJ (US); Allison Antonini, Union, NJ (US); Carol Wines, Longmont, CO (US); Gary A. Lewis, Strousberg, PA (US); Jennifer K. Thomas, Denville, NJ (US); Kristine Gerard, Golden Valley, MN (US); Julia Leigh DesRochers, Mahwah, NJ (US); Zena E. Forte, Blairstown, NJ (US)

Correspondence Address: THADDIUS J. CARVIS, 102 NORTH KING STREET, LEESBURG, VA, 20176, US

(21) Appl. No.: 10/842,392

(22) Filed: May 10, 2004

(51) Int. Cl. A23L 1/28

(52) U.S. Cl. 426/275

(57) ABSTRACT

Provided is a process for preparing filled cracker snacks containing a creamy, lubricious low A_{w}, and bake stable filler encased within crisp oven-baked cracker with efficiency and consistency despite the difficult rheology of the filler. In a first step, a smooth textured, bakable filling is prepared comprising an oil phase, an aqueous phase and a solids phase by a process comprising blending the ingredients and mixing with high shear to form a homogeneous filler having a viscosity of greater than 1.5×10⁵ centipoise. Also prepared are top and bottom sheets of cracker dough, the bottom of which is moved at a predetermined horizontal velocity for depositing a plurality of continuous or intermittent streams of a bakable filling thereon from a depositor comprising a plurality of openings. The top dough sheet is then placed over the bottom sheet, and the sheets are cut and/or scored in a predetermined pattern to form a composite unbaked dough and filling. Finally, the composite is baked sufficiently to provide a crisp outer crust that exhibiting textural and microbiological stability.

### RELATED APPLICATIONS

This application is related to the subject matter of U.S. patent applications Ser. No. 10/059843 and 10/059844, both filed Jan. 30, 2002, now United States Patent Publication Numbers 20020197354 and 20020155198, and U.S. patent application Ser. No. 10/616,726, filed Jul. 10, 2003, all commonly assigned with the present application.

### BACKGROUND OF THE INVENTION

The invention relates to the production of snack products comprised of a crisp cracker filled with a cheese or other oil-based filling, efficiently and without the need for prebaking the cracker portion. The process prepares and combines uncooked dough and filler components while maintaining the stability of both components during preparation, assembly, baking, packaging and storage. The process assures that the components and the combination at all times in processing maintain structural, compositional and microbiological stability.

The preparation of stable oil-based fillings capable of surviving the baking process has been a significant technical problem and has been addressed with considerable success in United States Patent Publication Numbers 20020197354 and 20020155198, as well as U.S. patent application Ser. No. 10/616,726 , filed Jul. 10, 2003. However, the handling of such fillers for depositing on cracker dough sheets in a uniform manner and then forming the cracker dough and baking it to achieve a shelf stable snack has also presented a challenge. It has been especially challenging to enable the formulation of such fillings and design of a process arrangement which enables forming cracker-based snacks at speeds readily handled by conventional cracker baking equipment. There is a need in the commercial setting to be able to quickly and efficiently change from one product formulation to another. The invention has been developed to enable such commercial scale production.

The commercial production of composite products where the weight must be controlled for a baked product by controlling the unbaked product presents further difficulties for the engineer trying to make filled cracker products. The final package weight of filled cracker products must be controlled, but variations can be introduced by a number of factors. Even where the formulation of the components is carefully controlled and careful quality checks are maintained, the final product weight can vary unless careful control is made of the portioning of both dough and filler components. Even completely eliminating variations in raw material specifications, mixing and baking will not provide the desired control of product portion weight. The techniques used for depositing the filler onto the dough and for trimming the composites to proper size, can play a major role in commercial success.

Typically, a package must contain a predetermined weight of product. Consumer satisfaction and regulations require as much. While minimum weights can be guaranteed by putting extra numbers of articles into each package, the producer does this at the expense of giving away a certain amount of the product. This problem is accentuated where the number of articles packaged is limited, for example where the product is packaged in single serving foil packages held within a carton. In these cases, the contents of an outer carton depend on a particular number of food items to be packaged and an underweight signal for the carton provides little choice but to either reject it or to add an additional internal foil pack—typically from one tenth to one fourth of the total package weight. There is a need to provide producers with methods and formulations that enable them to meet label specifications without significantly exceeding this amount.

The above-identified patent applications and publications describe fillers that are stable to baking, but is important to process them in a manner that assures uniformity of rheological and textural properties to achieve proper performance during automated formation of filled cracker products. It is essential for satisfactory commercial production that a technique and equipment be developed to consistently provide emulsion characteristics that will provide the desired stability and permit effective manipulation, once prepared, to provide portion controlled products. It was our experience that the art has not provided emulsification equipment effective for the commercialization of such a product. Then, when we developed the means to provide suitable stability on a commercial scale, the product rheology made further production difficult due to the consistency of the stabilized filler composition.

The prior art has developed a number of techniques for depositing a filler onto dough sheets, but control has not been addressed with a product of the type of the cheese and other fillers as described in the above-identified patent applications and publications. These fillers when processed to be stable to baking, are of high viscosity. With the wrong type of physical agitation the emulsions can be destabilized mechanically. Also a problem is the fact that these fillings are so viscous that certain types of depositing equipment used for product portion control, such as positive displacement pumps, cannot effectively handle them. Moreover, even with depositors offered by their manufacturers as suitable for handling thick pastes, we experienced problems of feeding them properly to assure that they could uniformly deposit the filler as necessary for uniform product production.

There remains a need in the art for suitable large scale processing enabling the production of a crisp cracker filled with a fully enclosed center of soft, creamy filler with excellent product characteristics and portion control.

### SUMMARY OF THE INVENTION

It is an object of the invention to provide a process for preparing baked filled cracker snack products on a commercial scale with consistent quality and weight control.

It is another object of the invention to provide a process for emulsification effective for the preparation of oil based bake stable emulsions of high viscosity and low A_{w} suitable for commercialization of a baked, filled cracker product.

It is another object of the invention to provide processing for preparing baked filled cracker snacks where the filling is deposited uniformly on unbaked cracker dough with a high degree of consistency and reproducibility.

It is another object of the invention to provide a process for preparing baked filled cracker snack products having stable fillings yet enabling their handling in a consistent manner.

It is yet another object of the invention to provide a process for preparing baked filled cracker snack products having stable fillings which employs an emulsification technique effective for the preparation of oil based bake stable emulsions of high viscosity and low A_{w} and utilizes an and auger fed filling arrangement capable of handling fillings processed into stable rheology suitable for commercialization of a baked, filled cracker product.

It is yet another object of the invention to provide a process for preparing baked filled cracker snack products having stable fillings and uniformly portioned dough and filler components.

It is yet another object of the invention to provide a process for preparing baked filled cracker snack products wherein the process provides a combination of processing steps necessary to create a creamy filler while maintaining low enough moisture in the end product for a crisp and flaky cracker.

These and other objects are achieved by the invention, which provides an improved process for preparing filled cracker snacks containing a creamy, lubricious low A_{w} and bake stable filler encased within crisp oven-baked cracker. In one aspect the process comprises: preparing a smooth textured, bakable filling comprising an oil phase, an aqueous phase and an optional solids phase by a process comprising blending the ingredients and mixing with high shear to form a homogeneous filler having a high viscosity, e.g., of from 1.5×10⁵ to 3.1×10⁵ centipoise at 25° C.; preparing top and bottom sheets of dockered cracker dough; moving the bottom sheet of dockered cracker dough along a supported surface at a predetermined horizontal velocity; depositing, preferably continuously, a plurality of streams of a bakable filling at a predetermined rate on the bottom sheet of dough; placing a top of sheet of dockered cracker dough over the bottom sheet of cracker dough having the bakable filling thereon; applying pressure, e.g., by means of a rotary cutter or a reciprocating cutter, to the dough sheets in predetermined areas to seal the bakable filling between the sheets of dough in a perimeter around discrete portions of bakable filling and to cut and/or score the dough in a predetermined pattern to form a composite comprised of unbaked dough and filling; and baking the composite sufficiently to provide a crisp outer crust that exhibits textural and microbiological stability.

In another embodiment, a bakable filling is deposited in discrete portions on the bottom sheet of dough in a regular pattern from a depositor comprising a plurality of depositor openings by causing the filling to flow at a predetermined rate from each of the plurality of openings, interrupting the flow to each of the openings at timed intervals and restarting the flow also at timed intervals, interruption and start of flow being coordinated with the predetermined horizontal velocity of the bottom sheet to provide discrete portions of bakable filling in a regular pattern.

In a particularly preferred aspect, the filling is processed by mixing in a high shear mixer having a heated vessel with counter rotating agitator blades and a saw-toothed blade positioned at the bottom of the vessel and rotated at a rotational speed effective to provide saw tooth tip speeds of from 20 to 60 feet per second and reduce the droplet size of fat droplets to within the range of from 1 to 5 μm at a temperature of from about 120° F. to 140° F.

In another particularly preferred aspect, the depositor is fed by a screw pump filling means including an auger rotated about a vertical axis to positively feed the screw pump filling means with the aid of gravity and without creating high shear on the filling during feeding.

Other preferred aspects of the invention are shown in the drawings and described below.

### BRIEF DESCRIPTION OF THE DRAWINGS

The invention will be better understood and its advantages will become more apparent from the following description, especially when read in light of the accompanying drawing, wherein:

FIG. 1 is a process flow diagram for a process arrangement of a preferred process layout of the invention;

FIG. 2 is a top perspective view showing one typical filled product form prior to baking;

FIG. 3 is a cross sectional side elevation view taken alone line 3-3 of the product shown in FIG. 2;

FIG. 4 is a perspective view of a cutter apparatus according to the invention;

FIG. 5a is a schematic side elevation, partially cut away and in cross section, of a mixing device for preparing the uniform viscous fillers for depositing according to the invention;

FIG. 5b is a perspective view of a saw tooth blade shown in FIG. 5a;

FIG. 5c is a top plan view of shown the saw tooth blade in FIG. 5a; and

FIG. 6 is a side elevation, partially cut away and in cross section, of an apparatus designed to feed the viscous filling to a depositor for depositing according to the invention.

### DETAILED DESCRIPTION

This invention provides processing for creating filled cracker snack products containing savory/salty/sweet, low moisture and low A_{w} (e.g., RH<35%) bake stable fillers from mixing unit operations through cracker stick formation using processing and equipment systems that have been enableded and integrated specifically for this process. The formulations and processing techniques of the aforementioned U.S. Patent Applications and Publications, namely in United States Patent Publication Numbers 20020197354 and 20020155198, as well as U.S. patent application Ser. No. 10/616,726 , filed Jul. 10, 2003, are hereby incorporated by reference in their entireties. While not limiting, representative of these formulations are those comprising from 5 to 55% of a fat phase and 20 to 50% of an aqueous phase. They will also desirably comprise at least 3% of dispersed solids. Reference is made to the above for specifics of formulations having various flavors. The invention makes the production of the described sweet and/or savory fillers in crisp crackers to be produced with a fully enclosed center of soft, creamy filler with excellent product characteristics and portion control.

The filler preparation of the invention includes the use of a high shear mixer, which contains a combination of high speed turbine rotor design and bulk mixing with temperature control to create a high viscosity (e.g., above about 150,000 centipoises at 25° C.), stable filler, the use of a high shear auger pumping system that does not create rheological changes to the filler, and a depositing system specifically designed to handle high viscosity and elastic fillers. Also, unique to the process is the dough formation in preparation for cracker stick assembly, including dual dough sheeting and lamination and perforation of both top and bottom sheets of dough as well as the cutter design. The systematic implementation of these various types of units in this specific processing configuration permits the development of a variety of filled baked products.

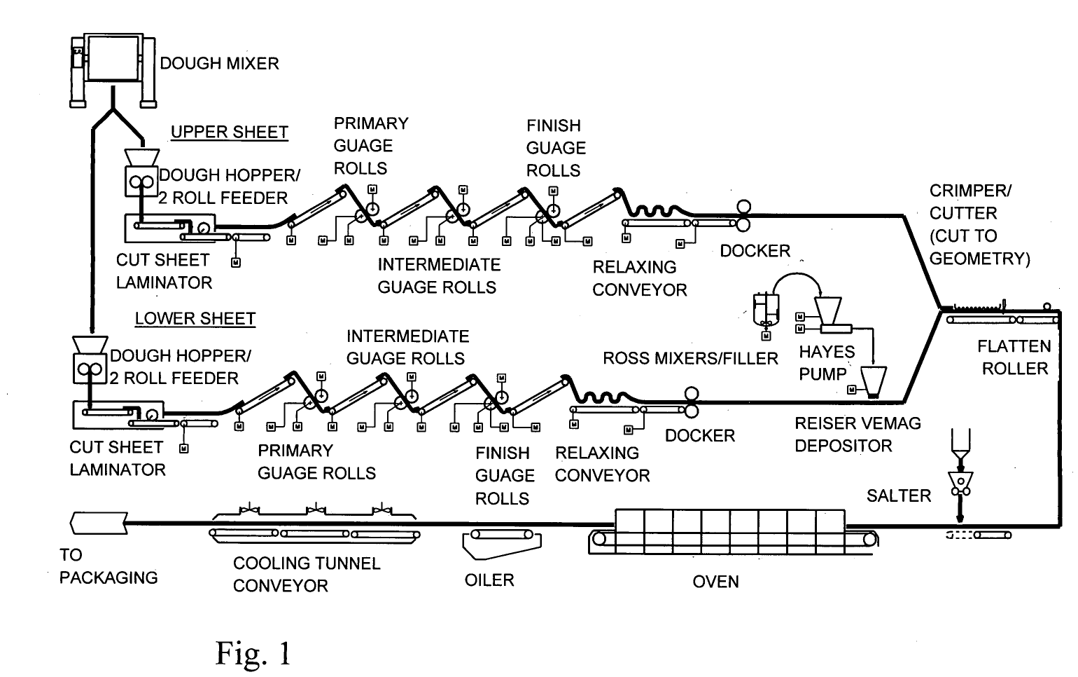

The invention provides the means to produce a crisp cracker filled with a fully enclosed center of soft, creamy filler that is included before baking, while permitting high line throughputs. The combination of processing steps enables the creation of a creamy filler while maintaining low enough moisture in the end product for a crisp and flaky cracker. Referring to the drawings, FIG. 1 is a schematic representation of a preferred process layout of the invention. Briefly, it shows the process as comprising as a first operation in the preparation of a smooth textured, bakable filling comprising an oil phase, an aqueous phase and optional solids phase by a process comprising blending the ingredients and mixing with high shear to form a homogeneous filler having a viscosity of from 1.5×10⁵ to 3.1×10⁵ centipoise at 25° C. It also shows preparing top and bottom sheets of cracker dough and dockering both of them prior to baking. The bottom sheet of dockered cracker dough is moved along a supported surface at a predetermined horizontal velocity; and a plurality of continuous or intermittent streams of a bakable filling are deposited on the bottom sheet of dough from a depositor at a predetermined rate. Once the filler is deposited, a top sheet of dockered cracker dough is placed over the bottom sheet of cracker dough and pressure is applied to the dough sheets in predetermined areas, e.g., by means of a rotary cutter or a reciprocating cutter, to seal the bakable filling between the sheets of dough in a perimeter around discrete portions of bakable filling and to cut and/or score the dough in a predetermined pattern to form a composite unbaked dough and filling. Then, FIG. 1 shows baking the composite sufficiently to provide a crisp outer crust that exhibits textural and microbiological stability.

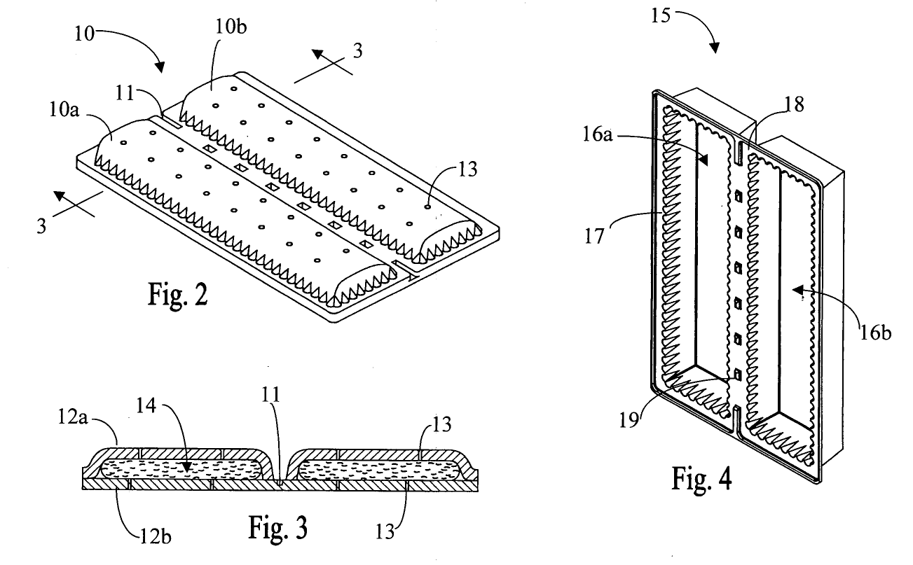

With the above process as just outlined and shown in FIG. 1, as exemplary of the improved process of the invention, we will now explain several of the specific process improvements which are combined into the process to best achieve its objectives. Also, described will be several preferred and alternative aspects for preparing products of the type shown as 10 in top perspective in FIG. 2, prior to baking. Product 10 is shown as containing two separable sticks separated by a frangible area 11 to facilitate breaking. FIG. 3 is a cross sectional side elevation view taken alone line 3-3 of the product 10 shown in FIG. 2. The cross section reveals a cheese or other creamy filling 14 between dockered top dough sheet 12a and bottom dockered dough sheet 12b, both having docker holes 13 therein. It will be clear from the discussion to follow that use of a cutter 15, such as shown in FIG. 4, to press against dough sheets having filler composition there between results in the shape as essentially shown in FIG. 2. The specific shape of the piece prior to baking, including the detail of the edge portions, can be varied as desired.

The cracker dough is made in the conventional way in a conventional dough mixer. Any of the various cracker favorites can be employed, such as soda cracker, wheat crackers or savory varieties sold under the brand name RITZ®, CHEESE NIPS®, WHEAT THINS® and the like. The dough will comprise flour, water, leavening, flavor and shortening in reasonable proportions. Typical formulations are shown, for example, in Manley, J. R., Technology of Biscuits, Crackers and Cookies, Vols. 1 and 2. Once fully mixed and proofed as desired for the particular cracker texture desired, the dough is fed to two separate sheeting apparatus. In FIG. 1, the top row in the drawing shows apparatus for preparing a top sheet and the bottom row shows the preparation of a bottom dough sheet. Both top and bottom sheets are formed in the same way. From the feed hopper, the dough for each is sheeted and fed to a cut sheet laminator wherein it is laminated to from 2 to 8 layers, e.g., about 4 to 6 layers, and gauged. Other laminators, such as swing arm laminators will also be effective.

The control of sheet thickness is very important to portion control and is achieved in three stages with primary gauge rolls, intermediate gauge rolls and finish gauge rolls. The final thickness of the dough sheets will preferably be from about 0.028 to about 0.038 inches. After sheeting and gauging, the sheets are relaxed on a relaxing conveyor for about 5 to 20 seconds, or so, and is then dockered. Dockering is important to permit moisture to exit during banking and maintain product size and shape following baking and will be typically in a uniform pattern with evenly spaced pins. The dockering pin sizes and location will be selected to enable effective moisture release during baking without fostering leakage of filler material. The pins for dockering the top sheet will have diameters of about 0.188 inches and those for the bottom sheet will have diameters of about 0.094 inches, in one preferred embodiment. The pins for the top sheet should be dockered effectively to provide maximum of moisture an gas release and can be larger than those for the bottom where the natural tendency for the filler to flow when heated will require smaller holes so as not to permit leaking of the filler onto the oven band.

The dockered bottom dough sheet is moved under the depositor at a uniform, predetermined speed, e.g., typically adjusted to provide a bake time (for the fully formed product) sufficient to fully bake the cracker in the oven employed, e.g., for from 7 to 9 minute bake time. The depositor will preferably deposit a plurality of preferably continuous (or intermittent) streams of a bakable filling on the bottom sheet of dough from a depositor comprising a plurality of depositor openings by causing the filling to flow at a predetermined rate from each of the plurality of openings. The depositor can be of the type produced by Robert Reiser & Co as a VEMAG (HP-15C model) Robot vacuum filler with a double screw and a multi-outlet waterwheel depositor. The number of openings will depend on, among other factors, the dimensions of the product, the width of the line and the cutter design.

The filler can be made according to the formulations as described in any of the aforementioned U.S. Patent Applications and Publications, namely in United States Patent Publication Numbers 20020197354 and 20020155198, as well as U.S. patent application Ser. No. 10/616,726, filed Jul. 10, 2003, which are hereby incorporated by reference in their entireties. As used according to the invention herein, the formulations will be prepared to have very low moisture contents, e.g. on the order of from 2 to 5%, preferably less than 4%. These percentages and all others in this description will be by weight unless specific mention to the contrary is made. The fillers will also preferably be high in dissolved solids and have A_{w} values of less than about 0.35 (i.e., a relative humidity of less than 35%) to assure crispness retention in the baked product. This combination of properties, plus the need for fine emulsification to achieve a stable emulsion and a creamy, lubricious mouth feel, has resulted in the development of processing that produces extremely high viscosities. The apparent viscosity of the preferred unbaked creamy fillers will typically fall within the range of from about 1.5×10⁵ to about 3.1×10⁵ centipoise as measured at 25° C. using a Rheometrics SR5000 stress rheometer (now TA Instruments, New Castle, Del.).

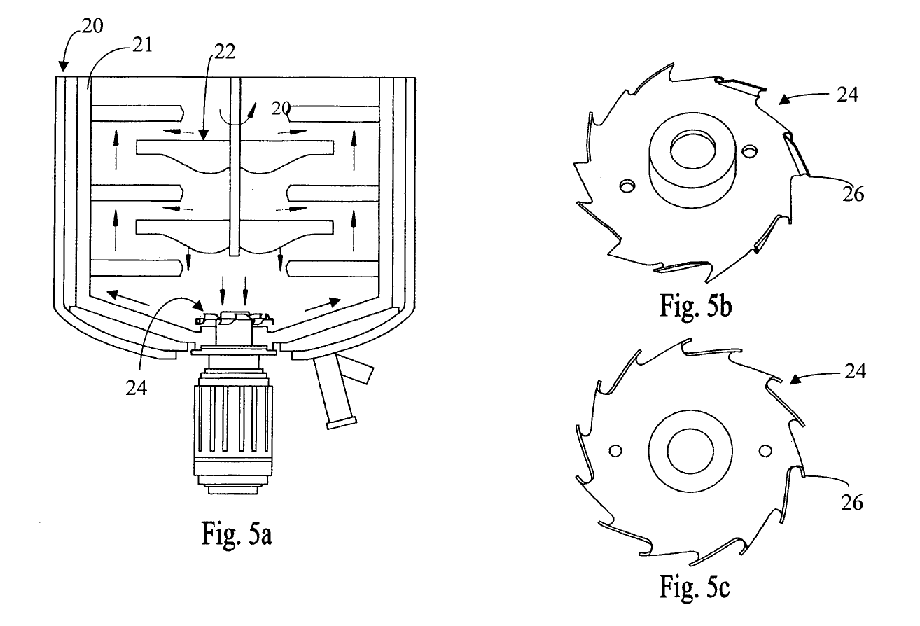

The development of a suitable emulsion to meet the objectives of the invention has required the design of an apparatus as shown in FIGS. 5a, 5b and 5c. In FIG. 5a, a cross sectional view is shown through a preferred form of high sheer mixer designed and engineered to mix the high viscosity materials of the invention. It typically consists of a vessel 20 having therein an outer anchor agitator 21, inner counter-rotating blades 22, and a bottom entering homogenizing turbine also known a saw tooth rotor configuration 24. The apparatus differs from those available from Charles Ross & Son Company as an Olsa Vacuum Mixer Homogenizer by virtue of the design of the saw tooth rotor 24, which is better seen in the views of FIG. 5b and FIG. 5c.

The blade 24 when used with a mixer designed for 50 liters (in which case a representative vessel 20 will have a diameter of 15.7 inches), has a diameter of 4.25 inches and includes fourteen saw-shaped teeth 26 spaced evenly about the periphery of the blade 24 which alternate upward and downward, much as a saw blade will alternate teeth. The person skilled in the art will appreciate the fact that dimensions and speeds can be varied within reason, and are given as exemplary only. The flow created by the agitators 21 and 22, in combination with the saw tooth configuration permit the high viscosity material to be subjected to high shear in an ever changing localized area such that the entire mass of filler ingredients is highly emulsified at uniform temperature conditions.

The outer anchor agitator 21 is designed to match the inner profile of the vessel 20 to provide sufficient agitation of the bulk and to continuously remove product from the vessel wall. Scrapers along the edges of agitator 21 enhance the highly efficient heat transfer between the surface of the vessel 20 and filler being processed. The scrapers are hinged but not spring loaded. The centrifugal force generated by the rotation of the anchor agitator 21 and the pressure of the filler acting on their surface, pull the scrapers towards the inner surface of the vessel 20. The resultant high heating and cooling efficiency prevents temperature differentials between the outer and inner sections of the vessel jacketed mixer bowl), resulting in a suitably uniform temperature of the filler bulk, which allows for improved heating and cooling time cycles.

Located inside the outer anchor agitator 21 and rotating in the opposite direction to it, the inner rotating blades 22 create a contrasting series of flows within the filler bulk. The axial flow design of inner agitator blades 22 generates a downward flow of the filler to ensure efficient vertical and horizontal mixing and prevent stratification of the filler. The outer anchor agitator 21 and inner counter-rotating blades 22 are driven by independent motor drives and can be independently controlled for maximum process flexibility. The homogenizing turbine or saw tooth rotor 24 is centrally positioned, entering from the bottom of the mixing vessel. This design approach provides an efficient flow of filler and to mix under high shear conditions. The rotor 24 is designed to provide high emulsifying and shearing action, effecting emulsification, dispersion, particle size reduction, dissolution and homogenization. The design of the rotor 24 is related directly to the type of filler to be processed to the required shear or flow rate.

The mixing vessel or jacket 20 is designed with a dished bottom, to obtain an ideal flow of the filler, especially in this case in which the filler is of a high viscosity nature. The outer part of the mixer shell includes the baffled jacket for effective heating and cooling operations. All heating/cooling lines for the vessel are routed internally to the lift housing, eliminating exposed hoses and fittings. Connections are terminated at bulkhead fittings on the side or rear of the lift housing. In the preferred form of the invention, the filling is processed by mixing in a mixer of this design at a radial speed effective to provide saw tooth tip speeds of from 20 to 60 feet per second and reduce the droplet size of fat droplets to within the range of from 1 to 5 μm at a temperature of from about 120° F. to 140° F. Rotation speeds for the various parts of the emulsifier will typically be within the range of from 20 to 40 rpm (clockwise) for the agitator 21, from 30 to 60 rpm for the inner counter-rotating blades 22, and from 750 to 1500 rpm for the rotor 24.

Upon completion of the mixing, the filler will need to be transported to the depositor hopper. A number of pumps were evaluated for advancing the viscous filler material from the emulsification apparatus to the depositor, and not all were unsuccessful. In order to properly feed the depositor with the high viscosity filler, it has been found that ordinary filler equipment dependent on metering pumps or other pumps or the provision of long screw feeders, would not provide positive feed to the degree necessary especially where portion control is so critical. To that end, the invention employs by the use of an auger pump having feed means associated to positively feed the filler material into a single or multiple metering screw device. In a preferred embodiment, a vertical auger provides an assist to move the homogenized filler material from a hopper to a screw fed depositor. With this type of positive feed to an auger pump, it is possible to deposit a plurality of streams of a bakable filling on the bottom sheet of dough from a depositor at a predetermined flow essential for smooth line operation and portion control.

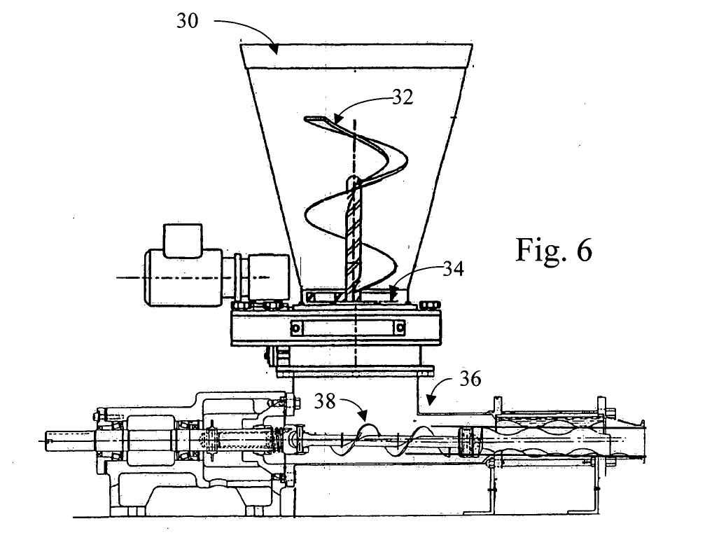

Of the devices tested, the only auger pumps that met the requirements of the invention are the use of a Hayes AugMentor™ Pump or a Doering Pump. The preference is for the Hayes AugMentor™ Pump Model FBC2F-SSE-SAA, because it permits improved control. FIG. 6 shows a suitable arrangement wherein a Hayes AugMentor™ is shown utilizing a vertical hopper 30 containing a rotational auger 32 to force the filler to be pumped into the open throat hopper 34 of the auger pump 36. A right angle gear motor controlled by a variable frequency AC drive controller drives the auger in a counterclockwise rotation (as viewed from the top). The pump operator can adjust the rotational speed of the auger 32 as required to provide for the best feed rate of the pump, which would feed the filler directly into the flights of the screw 38 for pumping. A minimum level of 6 to 8 inches of product should be maintained in the hopper during operation. This will help ensure that the pump remains full of product and air is not introduced into the product. This system is typically used for pumping materials, which require metered flows and/or constant pressure and are high in viscosity (e.g., greater than 100,000 centipoises) and cannot be pumped in the traditional manner. Such a system with means to provide an assist to move the homogenized filler material from a hopper to a screw fed depositor is a requirement for most effective pumping of the preferred viscous fillers. The depositor is thus fed filling by means of an auger 32 rotated about a vertical axis to positively feed the filling with the aid of gravity and without creating high shear on the filling during feeding. The augur pump 36 is thus able to pump the filler uniformly and enable the filling to flow at a predetermined rate to and out each of the plurality of openings in the depositor.

The next step in the process calls for depositing of filler ribbons onto the lower dough sheet prior to layering the upper dough sheet. This unit operation is desirably accomplished using a depositor such as a Robot HP 15C (VEMAG™) from Robert Reiser & Company using a waterwheel assembly. It can be operated continuously or intermittently. A number of other depositors were investigated during the process development phase of the project and all resulted in failure due to the high viscosity of the fillers and inconsistent filler weight distribution with the exception of the VEMAG™. The unit consists of an angled 30° hopper in which the filler is compressed in the hopper by a feed screw or auger and fed to the thread of double screws with aid of a gentle vacuum. A scraper attached to the feed screw can completely empty the hopper. The scraper is easily removed for cleaning purposes. The double screw transports the filler from the feed into the outlet of the machine. The double screws ensure that the filler is conveyed gently and evenly to the outlet. The same volume is conveyed with each rotation of the double screws, air being withdrawn from the filler by the vacuum system. The double screws feed until completely empty. The speed of the double screws and thus the quantity of filler portioned can be adjusted to the targeted weight. The broad range of available double screws enables the unit to be adapted to different fillers and pumping speeds. The screw configuration used for this application is desirably a 24-80 arrangement. The filler is then transported to a vane assembly or waterwheel where it pumped into an actuator assembly containing the specific number of depositor openings for feeding the filler onto the bottom dockered dough sheet with the proper dimensions.

The bakable filling is deposited on the dockered bottom sheet of dough from a plurality of continuous streams from a depositor. The filling flows at a predetermined rate from each of a plurality of depositor openings. In one preferred form, the openings are rectangular slits having a dimension of 45/64 inch width by 7/64 inch height. Typical rates of flow from a single opening are sufficient to form the filling on the dough sheet in a regular pattern at a uniform rate being approximately from 15 to 30% of the weight of the unbaked composite including the dockered top and bottom dough sheets.

In an alternative embodiment, the filler is deposited intermittently so that there is a border of dough surrounding each deposit of filler on the bottom dockered dough sheet. This embodiment entails depositing discrete portions of a bakable filling on the bottom sheet of dough in a regular pattern from the depositor. Again, the depositor will comprise a plurality of depositor openings, and the depositor will cause filler material to flow at a predetermined rate from each. But here, the flow will be interrupted from each of the openings at timed intervals and restarted also at timed intervals, interruption and start of flow being coordinated with the predetermined horizontal velocity of the bottom sheet to provide discrete portions of bakable filling in a regular pattern.

Following depositing the filling on the bottom sheet of dough, a top of dockered cracker dough is placed over the bottom sheet of cracker dough having the bakable filling thereon. Then, pressure is applied to the dough sheets in predetermined areas to seal the bakable filling between the sheets of dough in a perimeter around discrete portions of bakable filling and to cut and/or score the dough in a predetermined pattern to form a composite unbaked dough and filling. Depending on the particular product configuration, the pieces can be incompletely cut, i.e., scored, between them or can be essentially fully cut such that the products easily separate as desired. Typical of the preferred manner of doing this is to lay out a plurality of streams of filler on the bottom dough sheet and cover those with a top sheet of dough.

Then, a rotary cutter (tied in the case of continuous dough feed and filler depositing) having cavities formed as shown in FIG. 4, is pressed against the resulting composite of dough and filler to form two joined, but breakable cracker sticks 10a and 10b, as shown in FIG. 2, separated by a frangible area 11 to facilitate breaking. In the cross sectional side elevation view of FIG. 3, which is taken alone line 3-3 of the product 10 shown in FIG. 2, a cheese or other creamy filling 14 is shown between dockered top dough sheet 12a and bottom dockered dough sheet 12b, both having docker holes 13 therein. It will be clear from the discussion to follow that use of a cutter 15, such as shown in FIG. 4, to press against dough sheets having filler composition there between results in the shape as essentially shown in FIG. 2. The cutter 15 is comprised of a pair of recessed cavities 16a and 16b and cutting/scoring edge 17 around the periphery and separating the cavities 16a and 16b. The cutter 15 is desirably coated with Tufram H-O (General Magnaplate Corporation) release/wear coating to a thickness of 0.002 inch +/−0.0003 inch. The relief angles on this cutter and the scallop design at edge 17 are designed to ensure proper release of the dough sheet from the cutter. A central plane area 18 between the two cavities has a plurality of projections 19 to create areas of weakness in frangible area 11 in the product. Other cutters, including reciprocating cutters can be employed and untied cutters can be employed for intermediate feed operations.

As can be seen in FIG. 3, the filler 14 is encased within the dough sheets 12a and 12b. In a typical operation, four such two stick filled cracker snacks would be formed abreast and cut with a rotary cutter having four such dies for each pass. Other, preferably wider, line widths and associated cutters can be employed. A typical and preferred product form will have two sticks, 10a and 10b, extending the long dimension of a piece 10 as shown in FIG. 2. The dimensions will be any convenient size, e.g., 3½ to 4½ inches, say 4 inches, for the long dimension, with a width of, e.g., 2 to 3, say about 2½ inches total for the two sticks, and a thickness of a quarter inch. In a preferred product form, the two stick portion 10 shown in FIG. 2 will have a weight prior to baking on the order of 30 grams. Following baking, the same two stick portion will weigh on the order of about 26.3 grams and about 27.5 grams after application of topping oil. Following cutting, the composite is preferably passed through a flattening roller to adjust product thickness and better hold salt or other granular topping to be applied.

Prior to baking the flattened dough and filler composites are passed through a salter, or other device to provide a desired prebake finish. Then, the composites are baked to a final moisture content for the cracker on the order of from 2 to 5, preferably less than 4%. Typical ovens for crackers can be employed, such as forced air and direct gas fired ovens. While warm from the oven, the crackers are optionally sprayed with a topping oil at a rate sufficient to provide, e.g., about 4% oil. Importantly, the relative humidity for the final product will be less than 35%. The filled crackers are then cooled and packaged. In one preferred form portions baked from prebakes as shown in FIG. 2 are packaged in poly foil packs and six of these are placed in a protective carton.

The above description is intended to enable a person skilled in the art to practice the invention. It is not intended to detail all of the possible modifications and variations, which would become apparent to the skilled worker upon reading the description. It is intended, however, that all such modifications and variations be included within the scope of the invention, which is defined by the following claims. The claims are meant to cover the indicated elements and steps in any arrangement or sequence that is effective to meet the objectives intended for the invention, unless the context specifically indicates the contrary.

1. A process for preparing filled cracker snacks containing a creamy, lubricious low A_{w} and bake stable filler encased within crisp oven-baked cracker, comprising:
preparing a smooth textured, bakable filling comprising an oil phase, an aqueous phase and a solids phase by a process comprising blending the ingredients and mixing with high shear to form a homogeneous filler having a viscosity of greater than 1.5×10⁵ centipoise;
preparing top and bottom sheets of dockered cracker dough;
moving a bottom sheet of dockered cracker dough along a supported surface at a predetermined horizontal velocity;
depositing a plurality of streams of a bakable filling onto the bottom sheet of dough from a depositor comprising a plurality of openings by causing the filling to flow at a predetermined rate from each of the plurality of openings;
placing a top sheet of dockered cracker dough over the bottom sheet of cracker dough having the bakable filling in a regular pattern thereon;
applying pressure to the dough sheets in predetermined areas to seal the bakable filling between the sheets of dough in a perimeter around discrete portions of bakable filling and to cut and/or score the dough in a predetermined pattern to form a composite unbaked dough and filling; and
baking the composite sufficiently to provide a crisp outer crust that exhibiting textural and microbiological stability.

2. A process according to claim 1, wherein the depositor is fed filling by means of an auger rotated about a vertical axis to positively feed the filling with the aid of gravity and into an auger pump.

3. A process according to claim 1, wherein the filling is processed by mixing in a high shear mixer having a heated vessel with counter rotating agitator blades and a saw-toothed blade positioned at the bottom of the vessel and rotated at a rotational speed to provide saw tooth tip speeds of from 20 to 60 feet per second to reduce the droplet size of fat droplets to within the range of from 1 to 5 μm at a temperature of from about 120° F. to 140° F.

4. A process according to claim 1 wherein the top and bottom sheets are formed as a single sheet and folded over.

5. A process according to claim 1 wherein the top and bottom sheets are formed as separate sheets.

6. A process for preparing a filled, crisp and stable cracker snack food, comprising:
preparing a smooth textured, bakeable filling comprising an oil phase, an aqueous phase and a solids phase by a process comprising blending the ingredients and mixing with high shear to form a homogeneous filler having a viscosity of greater than 1.5×10⁵ centipoise;
preparing top and bottom sheets of dockered cracker dough;
moving a bottom sheet of dockered cracker dough along a supported surface at a predetermined horizontal velocity;
depositing discrete portions of a bakeable filling on the bottom sheet of dough in a regular pattern from a depositor comprising a plurality of openings by causing the filling to flow at a predetermined rate from each of the plurality of openings;
interrupting the flow to each of the openings at timed intervals and restarting the flow also at timed intervals, interruption and start of flow being coordinated with the predetermined horizontal velocity of the bottom sheet to provide discrete portions of bakeable filling in a regular pattern;
placing a top of cracker dough over the bottom sheet of cracker dough having the bakeable filling in a regular pattern thereon;
applying pressure to the dough sheets in areas not having the bakeable filling thereon sufficiently to seal the sheets of dough in a perimeter around discrete portions of bakeable filling and cutting and/or scoring in a predetermined pattern to form a composite unbaked dough and filling; and
baking the composite sufficiently to provide a crisp outer crust that exhibiting textural and microbiological stability.

7. A process according to claim 6, wherein the depositor is fed filling by means of an auger rotated about a vertical axis to positively feed the filling with the aid of gravity and without creating high shear on the filling during feeding.

8. A process according to claim 6, wherein the filling is processed by mixing in a high shear mixer having a heated vessel with counter rotating agitator blades and a saw-toothed blade positioned at the bottom of the vessel and rotated at a rotational speed of from 20 to 60 feet per second to reduce the droplet size of fat droplets to within the range of from 1 to 5 μm at a temperature of from about 120° F. to 140° F.

9. A process according to claim 6 wherein the top and bottom sheets are formed as a single sheet and folded over.

10. A process according to claim 6 wherein the top and bottom sheets are formed as separate sheets.

11. A process for preparing filled cracker snacks containing a creamy, lubricious low A_{w} and bake stable filler encased within crisp oven-baked cracker, comprising:
preparing a smooth textured, bakable filling having an A_{w} of less than 0.35 and comprising from 5 to 55% an oil phase and from 20 to 50% of an aqueous phase by a process comprising blending the ingredients and mixing with high shear to form a homogeneous filler having a viscosity of greater than 1.5×10⁵ centipoise, wherein the filling is processed by mixing in a high shear mixer having a heated vessel with counter rotating agitator blades and a saw-toothed blade positioned at the bottom of the vessel and rotated at a rotational speed effective to provide saw tooth tip speeds of from 20 to 60 feet per second to reduce the droplet size of fat droplets to within the range of from 1 to 5 μm at a temperature of from about 120° F. to 140° F.;
preparing top and bottom sheets of dockered cracker dough;
moving a bottom sheet of dockered cracker dough along a supported surface at a predetermined horizontal velocity;
depositing a plurality of continuous streams of a bakable filling on the bottom sheet of dockered dough from a depositor comprising a plurality of openings wherein the depositor is fed filling by means comprising an auger rotated about a vertical axis to positively feed the filling with the aid of gravity and without creating high shear on the filling during feeding and causing the filling to flow at a predetermined rate from each of the plurality of openings;
placing a top of dockered cracker dough over the bottom sheet of cracker dough having the bakable filling in a regular pattern thereon;
applying pressure to the dough sheets in predetermined areas to seal the bakable filling between the sheets of dough in a perimeter around discrete portions of bakable filling and to cut and/or score the dough in a predetermined pattern to form a composite unbaked dough and filling; and
baking the composite sufficiently to provide a crisp outer crust that exhibiting textural and microbiological stability.

12. A process according to claim 11 wherein the top and bottom sheets are formed as a single sheet and folded over.

13. A process according to claim 11 wherein the top and bottom sheets are formed as separate sheets.

14. A process according to claim 11 wherein the dough sheets are moved continuously and depositing is done continuously.

15. A process according to claim 11 wherein the dough sheets are moved intermittently and depositing is done intermittently.
